(19) United States
(12) Patent Application Publication
(10) Pub. No.: US 2004/0012297 A1
(43) Pub. Date: Jan. 22, 2004

(54) Motor with core, core and method for manufacturing core and motor with core

(76) Inventor: Hiromitsu Takei, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 10/283,619

(22) Filed: Oct. 30, 2002

(30) Foreign Application Priority Data
Nov. 2, 2001 (JP) 2001-337545

(51) Int. Cl. H02K 1/12

(52) U.S. Cl. 310/254

(57) ABSTRACT

A motor with core includes a rotor core and a stator core having a plurality of salient poles circularly arranged about the rotor core, each of the salient poles having a magnetic flux converging surface, wherein a slot is provided between adjacent ones of the magnetic flux converging surfaces, and each of the magnetic flux converging surfaces includes a minute protrusion that is formed in a step-like configuration and protrudes toward the rotor core. The minute protrusion has a width in a circumferential direction that is in a range between ½ and 3/2 of a width of the slot in the circumferential direction.

### BACKGROUND OF THE INVENTION

1. Field of the Invention

The present invention relates motors with core having a rotor core and a stator core with salient poles, in which extended ends of the salient poles that opposes the rotor core have magnetic flux converging surfaces for converging magnetic fluxes, cores for motors and a method for manufacturing cores and motors with cores.

2. Description of Related Art

Motors with core that are widely used are typically provided with a core that is formed from a body of stacked layers of electromagnetic steel plates. For example, a magnet-embedded type motor with divided cores shown in FIG. 8 includes an external case 1 and a stator core 2 formed from divided cores. Arcuate base sections 2a of the divided cores of the stator core 2 are circularly arranged and mounted in an adhering manner on an inner wall surface of the external case 1. Each of the arcuate base sections 2a is provided with a salient pole 2b. The salient poles 2a on the arcuate base sections 2a that are circularly arranged and mounted on the external case 1 radially extend toward the center of the stator core 2.

An extended end (an inner end) of each of the salient poles 2b is provided with a magnetic converging section (teeth section) that is formed with a generally arcuate configuration. Magnetic flux converging surfaces 2d formed on inner circumferential surfaces of the respective magnetic converging sections 2c are disposed opposite to and in close proximity of external circumferential surfaces of the rotor core 3 that is rotatably provided in the motor. Rotor magnets 3a are provided on the rotor core 3 and form magnetic fluxes which are converged through the magnetic flux converging surfaces 2d. Gaps that are defined by slot sections 4 are formed between the magnetic converging sections 2c, 2c that are disposed adjacent to one another in the circumferential direction.

In the example shown in FIG. 8, a plurality of rotor magnets 3a are mounted on the rotor core 3 in a manner that the rotor magnets 3a are embedded in the slits provided on the rotor core 3. If there are any play between each of the rotor magnets 3a and the corresponding slit, adhesive or other fixing means such as bolts may be used to reinforce the fixing of the rotor magnets 3a to the rotor core 3.

However, in the motor with core described above, the shape and size of the magnetic converging section 2c of the stator core 2 are generally determined by the size of the motor, the number of magnetic poles of the rotor and the like. Depending on the shape and size of the magnetic converging sections 2c, its magnetic circuits becomes unbalance, and cogging, torque ripples and back electromotive voltage distortion may be generated. In particular, in the magnet-embedded type motor with divided cores shown in FIG. 8, the rotor magnets 3a are not continuously provided. As a result, switching of magnetic poles do not smoothly take place, and saturated states often occur locally depending on the shape and disposed locations of the magnets. In addition, due to plays of the magnets at their fixing portions, the magnetic flux distribution may be disturbed, which may promote the cogging and torque ripples described above. As a result, the rotation performance is apt to further lowered.

### SUMMARY OF THE INVENTION

The present invention relates to a motor with core and a method for manufacturing cores which improves the cogging with a simple structure and also improves the rotation performance of the motor.

In accordance with an embodiment of the present invention, a motor with core includes a rotor core and a stator core having a plurality of salient poles circularly arranged about the rotor core, each of the salient poles having a magnetic flux converging surface, wherein a slot is provided between adjacent ones of the magnetic flux converging surfaces, and each of the magnetic flux converging surfaces includes a minute protrusion that is formed in a step-like configuration and protrudes toward the rotor core. In one aspect of the present invention, the minute protrusion has a width in a circumferential direction that is in a range between 1/2 and 3/2 of a width of the slot in the circumferential direction. The minute protrusions form counter waveforms having generally inversed torque values against the intrinsic cogging waveform. The torque of the counter waveform would favorably cancel, in particular, peak values of the cogging torque.

Also, in the motor with core in accordance with the present invention, the minute protrusion may be disposed generally in a central area or in proximity to the central area of the magnetic flux converging surface in the circumferential direction. Also, in the motor with core in accordance with the present invention, the width of the minute protrusion in the circumferential direction may be generally the same as the width of the slot in the circumferential direction. Furthermore, in the motor with core in accordance with the present invention, the minute protrusion may protrude in the radial direction in a protrusion amount ranging from 0.05 mm to 0.15 mm. When the minute protrusion has such a configuration and is disposed in such a location as described above, optimum results can be obtained.

Moreover, in the motor with core in accordance with the present invention, a rotor magnet is provided on the rotor, and the magnet has a rectangular rotation waveform. Also, in the motor with core in accordance with the present invention, the rotor magnet may be divided into a plurality of divided segments in the circumferential direction such that the rotor magnet may be formed from a plurality of the divided magnet segments. In one aspect of the present invention, the divided magnet segments are embedded in the rotor. As a result, the canceling action that is created by the counter waveform of the present invention is particularly effective against the cogging waveform that is generated when rectangular-shape rotation waveforms are used.

Also, a method for manufacturing a core in accordance with an embodiment of the present invention includes a press-forming step of press-forming a stator core having a plurality of salient poles in a state in which magnetic flux converging surfaces of the salient poles are connected in one piece to one another through connecting sections, and a cutting step, after the press-forming step, of cutting the connecting sections to separate the connecting sections from the magnetic flux converging surfaces while leaving minute protrusions in a step-like configuration on the magnetic flux converging surfaces. According to the method for manufacturing cores described above, the minute protrusions on the magnetic flux conversion surfaces that favorably achieve the effects described above can be readily formed with high precision.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows a transverse cross-sectional view of an assembled state of a divided type stator core in accordance with an embodiment of the present invention.

FIG. 2 shows a transverse cross-sectional view of a rotor core structure in accordance with an embodiment of the present invention that is used with the stator core indicated in FIG. 1.

FIG. 3 shows a diagram indicating a state of improved cogging torque in a motor in accordance with the present invention.

FIG. 4 shows a plan view in part of a divided type stator core that is manufactured in a press-forming process in accordance with an embodiment of the present invention.

FIG. 5 shows a plan view in part of a unitary type stator core that is manufactured in a press-forming process in accordance with an embodiment of the present invention.

FIG. 6 shows a transverse cross-sectional view of a magnet embedded type rotor core in accordance with another embodiment of the present invention.

FIG. 7 shows a transverse cross-sectional view of a magnet embedded type rotor core in accordance with still another embodiment of the present invention.

### DESCRIPTION OF PREFERRED EMBODIMENTS

Embodiments of the present invention are described in detail below with reference to the accompanying drawings.

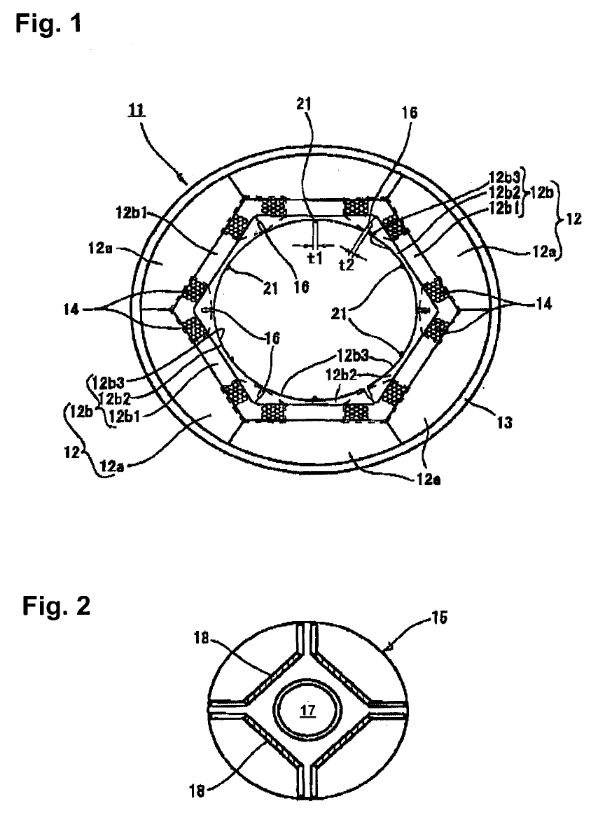

FIGS. 1 and 2 show an embodiment in which the present invention is applied to a six-pole stator core 11 that is used in an inner-rotor type motor with divided cores. The stator core 11 is divided in a circumferential direction and is thus formed from six divided cores 12. Outer circumferential base sections 12a of the divided cores 12 that are arranged in a ring shape in close contact with one another are disposed along an inner circumferential wall surface of a cylindrical sleeve-shaped motor case 13. Each of the outer circumferential base sections 12a of the divided cores 12 has a salient pole 12b that extends inwardly in a radial direction. The salient poles 12b on the outer circumferential base sections 12a of the divided cores 12 radially extend inwardly. Each of the salient poles 12b has a core rib section 12b1, and a coil 14 is wound on each of the core rib sections 12b1 through an insulator (not shown in the drawings).

Furthermore, a magnetic converging section 12b2 is provided in a radially inner end section of the core rib section 12b1 of each of the salient poles 12b. The magnetic converging section 12b2 is in a generally arcuate shape and extends from both sides of the core rib section 12b1 in the circumferential direction with the core rib section 12b1 as being the center. Each of the magnetic converging sections 12b2 has an inner circumferential surface that defines a magnetic flux converging surface 12b3. The magnetic flux converging surfaces 12b3 are disposed in the radial direction and in close proximity of an external circumferential surface of the rotor core 15 disposed on the inner side of the stator core 11 (see FIG. 2).

The magnetic converging sections 12b2 are disposed adjacent to one another along the circumferential direction, and slot sections 16 that define gaps are provided between adjacent ones of the magnetic converging sections 12b2 pairing along the circumferential direction.

The rotor core 15 in accordance with the present embodiment has a four-pole structure that is affixed on a rotor shaft 17, as indicated in FIG. 2. Four divided rotor magnets 18 in plate-shape are embedded in slits formed in the rotor core 15. The rotor magnets 18 of the present embodiment are disposed discontinuously in the circumferential direction, and thus create a rotation waveform in rectangular shape. Each of the divided rotor magnets may be formed from, for example, a sintered magnet or a bonded magnet. If there is any play between the divided rotor magnets and the slits on the rotor core 15, adhesive or other fixing means such as bolts may be used to reinforce the fixing of the magnets on the rotor core 15.

Each of the magnetic flux converging surfaces 12b3 of the respective salient poles 12b includes a minute protrusion 21 that is formed in a step-like configuration and protrudes by a minute amount in the radial direction toward the rotor core 15. The minute protrusion 21 may be disposed generally in a central area of the magnetic flux converging surface 12b3 in the circumferential direction or in proximity to the central area of the magnetic flux converging surface 12b3 in the circumferential direction. The slot 16 has a width t2 in the circumferential direction, and the minute protrusion 21 may preferably have a width t1 in the circumferential direction ranging from about half (1/2) to about 1.5 times (3/2) the width t2 of the slot 16 in the circumferential direction (i.e., (1/2)×t2≦t1≦(3/2)×t2).

Within the range described above, in accordance with the present embodiment, the width t1 of the minute protrusion 21 in the circumferential direction may preferably be set to be generally the same as the width t2 of the slot section 16 in the circumferential direction (i.e., t1≅t2). Furthermore, the minute protrusion 21 may protrude in the radial direction by a protrusion amount ranging from about 0.05 mm to about 0.15 mm.

In this manner, in the motor with core in accordance with the present embodiment, the magnetic flux converging surfaces 12b3 of the salient poles 12b are provided with the minute protrusions 21 that protrude by a minute amount in the radial direction toward the rotor core 15. As a result, the magnetic actions of the minute protrusions 21 form counter waveforms having generally inversed torque values against the intrinsic cogging waveforms; the torque of the counter waveforms would favorably cancel, in particular, peak values of the cogging torque.

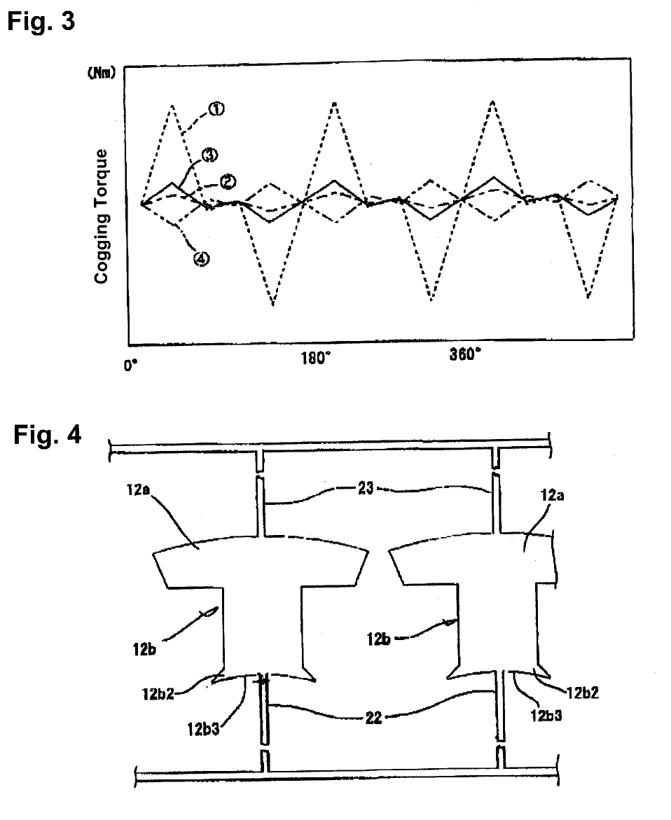

For example, FIG. 3 shows cogging torque (taken along a longitudinal axis) with respect to angles in a rotation direction (taken along a transverse axis) in a conventional motor apparatus indicated with a broken line \mathring{1} and in the motor of the present embodiment indicated with a dot-and-dash line \mathring{2}. As indicated in FIG. 3, peak values of the cogging torque in the motor of the present embodiment (dot-and-dash line \mathring{2}) are substantially reduced compared to the conventional motor apparatus (broken line \mathring{1}). In the above embodiment, the width t1 of the minute protrusion 21 in the circumferential direction is set to be generally the same as the width t2 of the slot section 16 in the circumferential direction (i.e., t1≅t2). When the width t1 of the minute protrusion 21 in the circumferential direction is set to be about 1.5 times the width t2 of the slot section 16 in the circumferential direction (t1≅1.5×t2), peak values of the cogging torque can also be substantially lowered as indicated by a solid line \mathring{3} although to a lesser extent compared to the embodiment described above. When the width t1 of the minute protrusion 21 in the circumferential direction is set to be about 0.5 times the width t2 of the slot section 16 in the circumferential direction (t1≅0.5×t2), cogging torque appears, as indicated by a two-dot-and-dash line \mathring{4} in FIG. 3, in regions opposite to those of the cogging torque shown in each of the embodiments described above, and it is observed that absolute values of its peak values are lowered to a level similar to the above embodiment in which the width t1 is set to be about 1.5 times the width t2.

The stator core 11 having the minute protrusions 21 can be formed through an ordinary press processing. In an embodiment shown in FIG. 4, the stator core 11 may be punched out of a steel plate through a press-processing. More specifically, plate sections each having a salient pole 12b, a magnetic converging section 12b2 with a magnetic flux converging surface 12b3 connecting in a unitary fashion to a band-like connection section 22 and an external circumferential base section 12a connecting in a unitary fashion to a thin band-like connection section 23 are formed. In other words, at this stage, a plurality of salient poles 12b that are arranged side by side in a single line and connected to one another through the connecting sections 22 and 23 are press-formed.

Then, a cutting process is conducted to cut the connecting sections 22 and 23 to separate the connecting sections 22 and 23 from the magnetic flux converging surfaces 12b3 and the external circumferential base section 12a, respectively. As a result, the plurality of salient poles 12b are separated from one another.

When cutting the connecting sections 22 and 23 in the cutting process, the connecting sections 22 are cut in a manner to leave minute protruded sections that define the aforementioned minute protrusions 21 on the magnetic flux converging surfaces 12b3. Each of the minute protruded sections may be in a rectangular shape or a step-like shape. According to the method for manufacturing cores including the steps described above, the minute protrusions 21 that favorably achieve the effects described in the aforementioned embodiments can be readily formed with high precision.

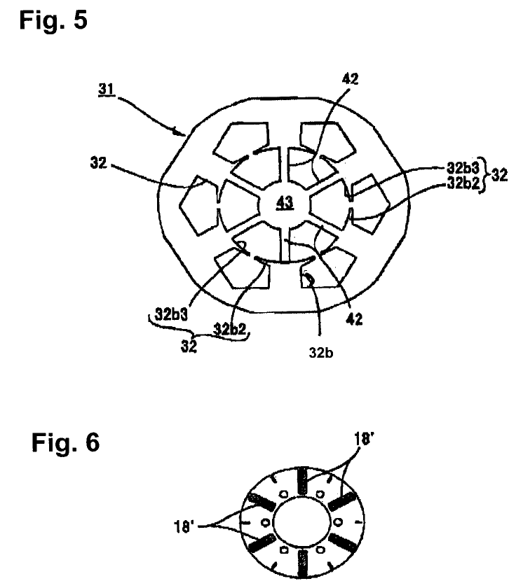

FIG. 5 shows another embodiment in which a unitary type stator core 31 is formed by a press-process. A stator core section having a plurality of salient poles 32b with magnetic flux converging surfaces 32b3 connecting in a unitary fashion to band-like connecting sections 42 extending in the radial direction is formed. Each of the connecting sections 42 may connect to a central section of each of the magnetic flux converging surfaces 32b3 in the circumferential direction. The connecting sections 42 thus formed converge toward a holding plate 43 disposed at the center of the core.

In this manner, the stator core 31 having the connecting sections formed in a unitary fashion is press-formed, and then the connecting sections 42 are cut in a cutting process to separate the connecting sections 42 from the respective magnetic flux converging surfaces 32b3. When cutting the connecting sections 42 in the cutting process, the connecting sections 42 are cut in a manner to leave minute protruded sections that define the aforementioned minute protrusions 21 on the magnetic flux converging surfaces 32b3. Each of the minute protruded sections may be in a rectangular shape or a step-like shape. According to the method for manufacturing cores including the steps described above, the minute protrusions 21 that favorably achieve the effects described in the aforementioned embodiments can be readily formed with high precision.

Specific examples of the embodiments of the present invention have been described above. However, the present invention is not limited to those embodiments described above, and many modifications can be made without departing from the subject matter of the present invention.

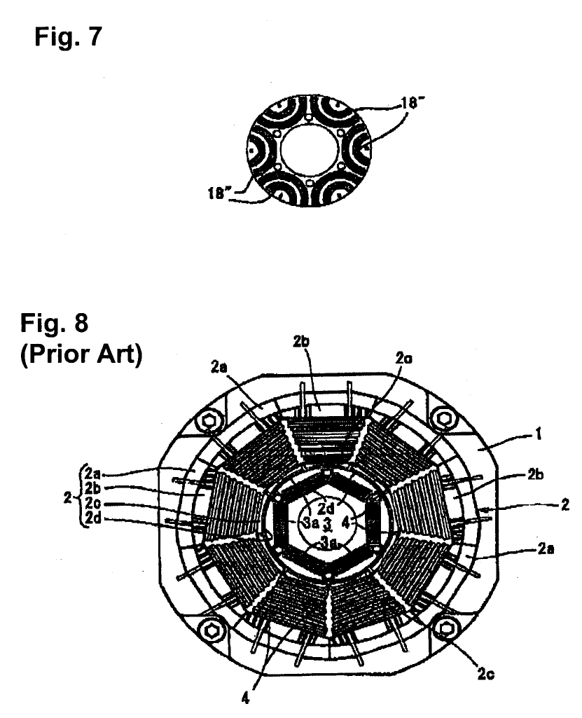

For example, FIG. 6 shows a rotor core for a magnet-embedded type motor to which the present invention is applicable. The rotor core shown in FIG. 6 includes plate-like rotor magnets 18′ that extend in the radial direction and circularly arranged in the rotor core. FIG. 7 also shows another rotor core for a magnet-embedded type motor in which rotor magnets 18″ in arc shape are disposed in layers and circularly arranged in the rotor core. In this manner, the present invention is applicable to a variety of types of magnet-embedded type motors.

Also, the present invention is similarly applicable to motors having structures other than that of the magnet-embedded type motor. Furthermore, the present invention is not limited to such inner-rotor type motors as described in the embodiments above, but is likewise applicable to motors having other structures such as outer-rotor type motors.

As described above, in accordance with the present invention, a motor with core includes a rotor core and a stator core having a plurality of salient poles circularly arranged about the rotor core, each of the salient poles having a magnetic flux converging surface, wherein a slot is provided between adjacent ones of the magnetic flux converging surfaces, and each of the magnetic flux converging surfaces includes a minute protrusion that is formed in a step-like configuration and protrudes toward the rotor core. The minute protrusion may have a width in a circumferential direction that is in a range between 1/2 and 3/2 of a width of the slot in the circumferential direction. As a result, the minute protrusions form a counter waveform having generally inversed torque values against the intrinsic cogging waveform. The counter waveform would favorably cancel, in particular, peak values of the cogging torque. Consequently, the rotation performance of the motor with core can be substantially improved with a relatively simple structure.

Also, in the motor with core in accordance with the present invention, the minute protrusion may be disposed generally in a central area or in proximity to the central area of the magnetic flux converging surface in the circumferential direction. Also, in the motor with core in accordance with the present invention, the width of the minute protrusion in the circumferential direction may be generally the same as the width of the slot in the circumferential direction. Furthermore, in the motor with core in accordance with the present invention, the minute protrusion may be set to protrude in the radial direction by a protrusion amount ranging from about 0.05 mm to about 0.15 mm. When the minute protrusion has such a configuration as described above, the effects described above can be favorably obtained.

Moreover, in the motor with core in accordance with the present invention, a rotor magnet provided on the rotor may be magnetized to create a rectangular rotation waveform. Also, in the motor with core in accordance with the present invention, the rotor magnet may be divided into a plurality of divided segments in the circumferential direction such that the rotor magnet may be formed from a plurality of the divided magnet segments. In one aspect of the present invention, the divided magnet segments are embedded in the rotor. As a result, the canceling action that is created by the counter waveform of the present invention is particularly effective against the cogging waveform that is generated when a rectangular-shape rotation waveform is used.

Also, a method for manufacturing a core in accordance with the present invention includes a press-forming step of press-forming a stator core having a plurality of salient poles in a state in which magnetic flux converging surfaces of the salient poles are connected in one piece to one another through connecting sections, and a cutting step, after the press-forming step, of cutting the connecting sections to separate the connecting sections from the magnetic flux converging surfaces while leaving minute protrusions in a step-like configuration on the magnetic flux converging surfaces. As a result, the minute protrusions on the magnetic flux conversion surfaces that favorably achieve the effects described above can be readily formed with high precision, and the motor with core in accordance with the present invention can be effectively manufactured.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor with core comprising:
a rotor core and a stator core having a plurality of salient poles circularly arranged about the rotor core, each of the salient poles has a magnetic flux converging surface, wherein a slot is provided between adjacent ones of the magnetic flux converging surfaces, and each of the magnetic flux converging surfaces includes a minute protrusion that is formed in a step-like configuration and protrudes toward the rotor core.

2. A motor with core according to claim 1, wherein the minute protrusion has a width in a circumferential direction that is in a range between 1/2 and 3/2 of a width of the slot in the circumferential direction.

3. A motor with core according to claim 1, wherein the minute protrusions form a counter waveform having generally inverse torque values against an intrinsic cogging waveform such that the counter waveform substantially cancel peak values of a cogging torque.

4. A motor with core according to claim 1, wherein the minute protrusion is disposed generally in a central area of the magnetic flux converging surface in the circumferential direction.

5. A motor with core according to claim 1, wherein the width of the minute protrusion in the circumferential direction is generally the same as the width of the slot in the circumferential direction.

6. A motor with core according to claim 1, wherein the minute protrusion protrudes in the radial direction by a protrusion amount ranging from about 0.05 mm to about 0.15 mm.

7. A motor with core according to claim 1, wherein a rotor magnet is provided on the rotor, and the rotor magnet is magnetized to create a rectangular rotation waveform.

8. A motor with core according to claim 1, wherein the rotor magnet is divided into a plurality of divided segments in the circumferential direction such that the rotor magnet is formed from a plurality of divided magnet segments.

9. A motor with core according to claim 8, wherein each of the divided magnet segments is embedded in the rotor core.

10. A method for manufacturing a motor with core, the method comprising:
a step of press-forming a stator core having a plurality of salient poles in a state in which magnetic flux converging surfaces of the salient poles are connected to one another through connecting sections; and
a step of cutting the connecting sections to separate the connecting sections from the magnetic flux converging surfaces while leaving minute protrusions on the magnetic flux converging surfaces.

11. A method according to claim 10, further comprising a step of preparing the stator core in a circular configuration such that the plurality of salient poles extend inward in a radial direction, a step of providing a slot section between adjacent ones of the magnetic flux converging surfaces, and a step of forming the minute protrusion to have a width in a circumferential direction that is in a range between 1/2 and 3/2 of a width of the slot section in the circumferential direction.

12. A method according to claim 11, wherein the minute protrusion is disposed generally in a central area of the magnetic flux converging surface in the circumferential direction.

13. A method according to claim 11, wherein the width of the minute protrusion in the circumferential direction is generally the same as the width of the slot in the circumferential direction.

14. A method according to claim 10, wherein the minute protrusion protrudes in the radial direction by a protrusion amount ranging from about 0.05 mm to about 0.15 mm.

15. A method according to claim 10, further comprising a step of providing a rotor core opposite to the magnetic flux converging surfaces of the salient poles of the stator core and a rotor magnet on the rotor core, wherein the rotor magnet is magnetized to create a rectangular rotation waveform.

16. A method according to claim 15, wherein the rotor magnet is divided into a plurality of divided segments in the circumferential direction such that the rotor magnet is formed from a plurality of divided magnet segments.

17. A method according to claim 16, wherein each of the divided magnet segments is embedded in the rotor core.

18. A method for manufacturing a stator core for a motor with core, the method comprising:
a step of press-forming a plurality of salient poles having magnetic flux converging surfaces that are connected to one another in one piece through connecting sections; and
a step of cutting the connecting sections to separate the connecting sections from the magnetic flux converging surfaces while leaving minute protrusions on the magnetic flux converging surfaces.

19. A method according to claim 18, wherein each of the minute protrusions has a step-like configuration.

20. A method according to claim 18, further comprising a step of preparing the stator core in a circular configuration such that the plurality of salient poles extend inward in a radial direction, a step of providing a slot section between adjacent ones of the magnetic flux converging surfaces, and a step of forming the minute protrusion to have a width in a circumferential direction that is in a range between 1/2 and 3/2 of a width of the slot section in the circumferential direction.

21. A method according to claim 18, wherein the minute protrusion is disposed generally in a central area of the magnetic flux converging surface in the circumferential direction.

22. A method according to claim 20, wherein the width of the minute protrusion in the circumferential direction is generally the same as the width of the slot in the circumferential direction.

23. A method according to claim 18, wherein the minute protrusion protrudes in the radial direction by a protrusion amount ranging from about 0.05 mm to about 0.15 mm.
